(19) United States
(12) Patent Application Publication
(10) Pub. No.: US 2008/0238938 A1
(43) Pub. Date: Oct. 2, 2008

(54) EFFECTS FOR INTERACTIVE GRAPHIC DATA IN DISC AUTHORING

(76) Inventors: Don Eklund, Yorba Linda, CA (US); Sumit Malik, Pasadena, CA (US); Raja Sahi, Los Angeles, CA (US); Tommy Choy, Lakewood, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/467,883

(22) Filed: Aug. 28, 2006

Related U.S. Application Data
(60) Provisional application No. 60/712,664, filed on Aug. 29, 2005.
(60) Provisional application No. 60/712,684, filed on Aug. 29, 2005.

(51) Int. Cl. G09G 5/00

(52) U.S. Cl. 345/629

(57) ABSTRACT

Authoring a Blu-ray Disc including: defining layers of graphics to be used in a display; overlaying the layer on to video display thereby providing a composite display, wherein overlay includes using an effect.

### RELATED APPLICATION

This application claims the benefit of priority of co-pending U.S. Provisional Patent Application Ser. No. 60/712,664, entitled “Disc Authoring” and co-pending U.S. Provisional Patent Application Ser. No. 60/712,684, entitled “Abstractions in Disc Authoring” both filed Aug. 29, 2005. This application is also related to U.S. patent application Ser. No. ______ entitled “Abstractions in Disc Authoring”, Attorney Docket No. 113748-6001US, filed on the same day as this application. The disclosures of the above-referenced patent applications are hereby incorporated by reference.

### BACKGROUND

The present invention relates generally to disc authoring and, more particularly, to adding effects to interactive graphic data in authoring optical discs such as Blu-ray Discs.

A media authoring system is typically used to generate articles of media that are compliant with a particular standard. For example, a Digital Versatile Disc (DVD) authoring system is used to generate data, such as audio and video data and information used to present and access the audio and video data, on a DVD. The data on the disc is stored according to standards defined for DVD. Similarly, a Blu-ray Disc (BD) authoring system is used to create optical discs storing information according to the standards defined for BD.

The BD Read Only Memory specification includes interactive graphics that allow a user to select options while viewing, or interacting, with the BD. Generating and implementing these interactive graphics can be burdensome to the disc author.

Therefore, there is a need for improved techniques for authoring interactive graphics for BD.

### SUMMARY

Implementations of the present invention include systems and methods to implement techniques for disc authoring using effects in interactive graphics, such as in authoring optical discs compliant with Blu-ray Disc.

In one implementation, a method for authoring a Blu-ray Disc includes: defining layers of graphics to be used in a display; and overlaying the layer on to video display thereby providing a composite display, wherein overlay includes using an effect.

In another implementation, a Blu-ray Disc authoring system includes: a graphics stream; and an effect comprising a series of compositions, wherein the compositions operate to display the graphics stream in a composite output.

In still another implementation, a computer program, stored in a computer-readable storage medium, for authoring a Blu-ray Disc, the program including executable instructions that cause a computer to: define layers of graphics to be used in a display; and overlay the layers of graphics onto a display thereby providing a composite display, wherein overlaying includes using an effect.

In yet another implementation, a computer program, stored in a computer-readable storage medium, for authoring a Blu-ray Disc, the program including executable instructions that cause a computer to: identify a graphics plane; and generate a series of compositions, wherein the compositions operate to display the graphics plane in a composite output.

The techniques have been described using BD, but the techniques are also applicable to DVD, HD-DVD, and iHD. In addition, the techniques for effects can be applied to a single object, or to several objects all executing at the same time.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be understood in part by studying the accompanying drawings, in which like reference numerals refer to like parts, and in which:

FIG. 1 provides a simplified overview of the BD-ROM data structure;

FIG. 2 shows Index Table, which is a top-level table structure that defines the Titles of a BD-ROM disc;

FIG. 3 illustrates one example of a Movie Object including navigation commands that can launch Playlist playback or another Movie Object;

FIG. 4 illustrates one example of Playlists, which are a collection of playing intervals in the Clips that indicates which portion of the Clip to play and when to play the Clip;

FIG. 5 is a block diagram of an example Clip;

FIG. 6 is a diagram illustrating a combination of planes into a composite output;

FIG. 7 is a diagram illustrating two layers that make up the example interactive graphics plane illustrated in FIG. 6;

FIG. 8 is a diagram illustrating aspects of an In effect;

FIG. 9 is a diagram illustrating aspects of an Out effect;

FIG. 10 is a block diagram illustrating aspects of a middle effect;

FIG. 11 is a diagram illustrating temporal relationships between In effects, Middle effects, and out effects;

FIG. 12 is an example dialog box that allows a user to control In and Out effects;

FIG. 13 is a flow diagram of a method of implementing In effects;

FIG. 14 is a flow diagram of a method of implementing a Transition effect;

FIG. 15A shows a representation of a computer system and a user; and

FIG. 15B shows a block diagram of one implementation of the computer system in FIG. 15A, including the BD authoring system.

### DETAILED DESCRIPTION

As will be further described below, implementations of the present invention provide an efficient structure and configuration in authoring articles of media that are compliant with a particular standard. In one implementation, a Blu-ray Disc (BD) authoring system executes instructions to store information based on the BD standard specifications using interactive graphics. After reading this description it will become apparent to one skilled in the art how to implement the invention in various implementations and applications. However, although various implementations of the present invention will be described herein, it is understood that these implementations are presented by way of example only, and not limitation. As such, this detailed description of various implementations should not be construed to limit the scope or breadth of the present invention as set forth in the appended claims.

In one implementation, the BD Read Only Memory (BD-ROM) specification provides a number of data structures that needs to be defined on a BD in order for the disc to behave as desired. The BD-ROM specification defines BD Prerecorded and BD Recordable application formats.

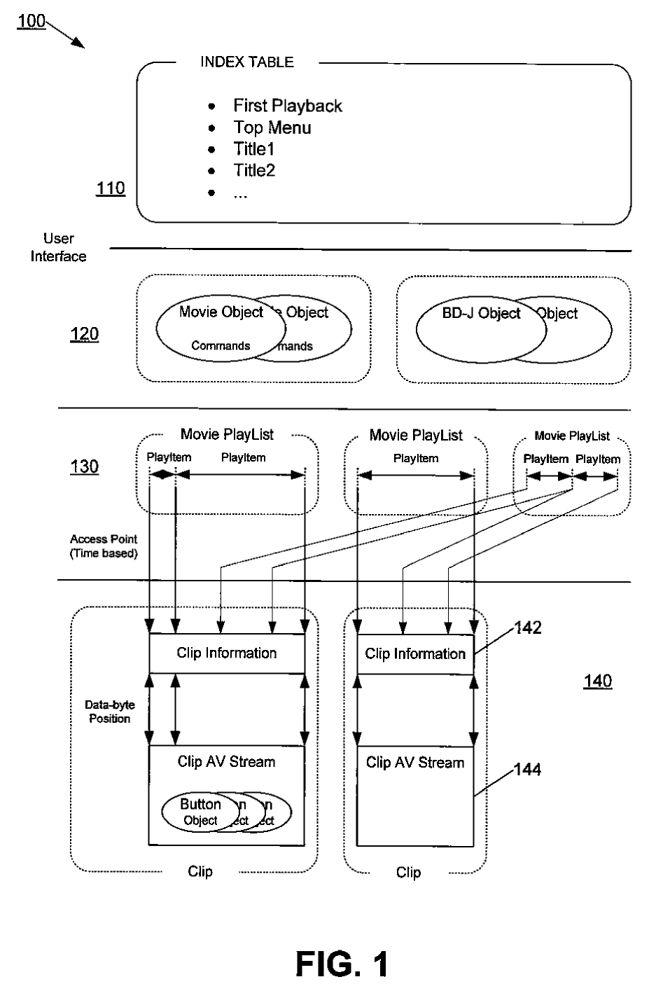

FIG. 1 provides a simplified overview of the BD-ROM data structure 100. In general, BD-ROM has four layers for managing AV stream files as follows: Index Table 110, Movie Object/BD-J Object 120, Playlist 130, and Clip 140.

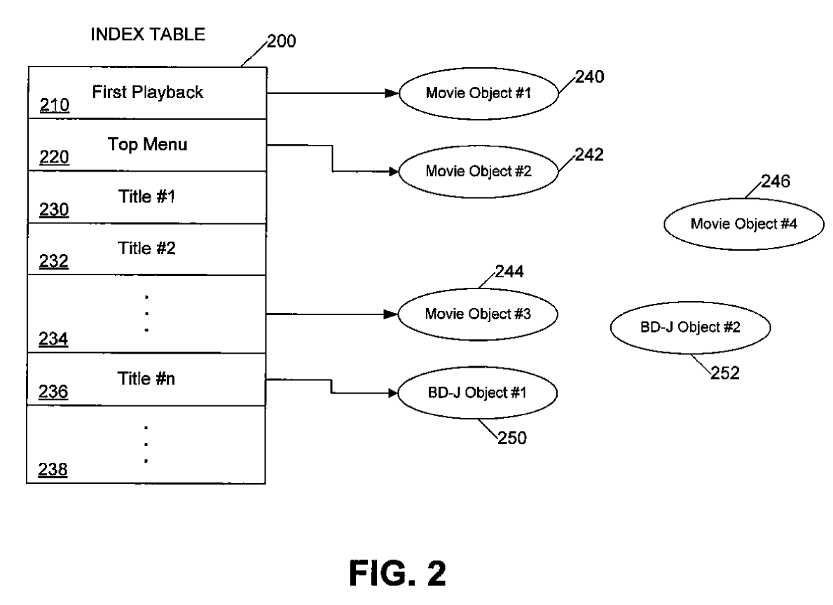

An example Index Table 200, shown in FIG. 2, is a top-level table structure that defines the Titles of a BD-ROM disc. A Title corresponds to any entry in the Index Table including First Playback 210, Top Menu 220, and Titles 230, 232, 234, 236, 238. First Playback 210 is used by content providers to perform automatic playback. Each Index Table entry links to either a Movie Object 240, 242, 244, 246 or BD-Java (BD-J) Object 250, 252. The disc player references this table whenever a title is to be executed (e.g. whenever the Title Search or Menu Call operation is called).

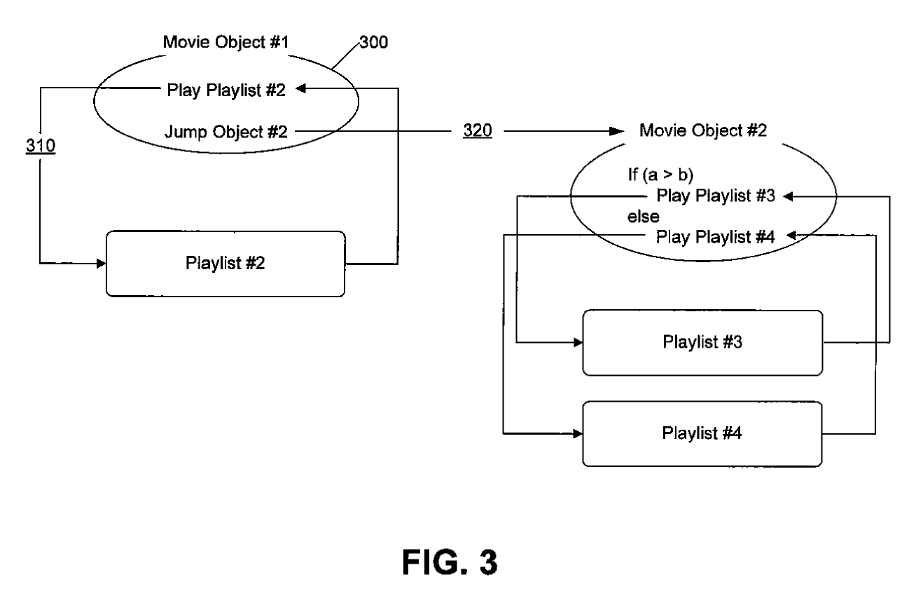

A Movie Object includes executable lines of codes or navigation commands which enables dynamic scenario description. Thus, as shown in FIG. 3, navigation commands in a Movie Object (e.g., 300) can launch Playlist playback 310 or another Movie Object 320. This enables the content providers to define a set of Movie Objects for managing playback of Playlists in accordance with a user's interaction and preferences.

When a Title associated with a BD-J Object in the Index Table on disc is selected, the corresponding application is automatically launched and its lifecycle is bound to the Title. A BD-J application is a Java Xlet which is controlled by the BD-ROM player's Application Manager through its Xlet interface. The Xlet interface has four states as follows: loaded, paused, active and destroyed. Once a BD-J application is destroyed, any resources allocated to it, such as memory and AV control, is released.

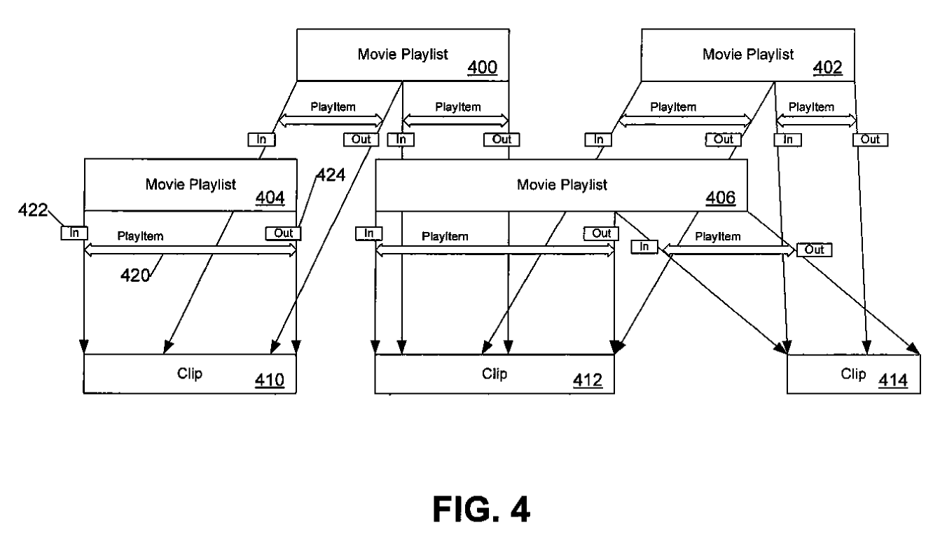

A Playlist (i.e., “Movie Playlist”) 400, 402, 404, 406, illustrated in FIG. 4, is a collection of playing intervals in the Clips 410, 412, 414 that indicates which portion of the Clip to play and when to play the Clip. One such playing interval is called a PlayItem (e.g., 420) and includes an IN-point (e.g., 422) and an OUT-point (e.g., 424), each of which refers to positions on a time axis of the Clip. The IN-point indicates a start point of a playing interval, and the OUT-point indicates an end point of the playing interval.

Referring back to FIG. 1, an AV stream file together with its associated database attributes is considered to be one object. In the context of the BD-ROM data structure, the AV stream file is referred to as a Clip AV stream file 144, and the associated database attribute file is referred to as a Clip Information file 142. An object including the Clip AV stream file 144 and its corresponding Clip information file 142 is referred to as a Clip 140.

The Clip Information file 142 stores the time stamps of the access point into the corresponding AV stream file 144. The BD player reads the Clip Information file 142 to find out the position where it should begin to read the data from the Clip AV stream file 144. Therefore, there is a one-to-one relationship between a Clip AV stream file 144 and a Clip Information file 142.

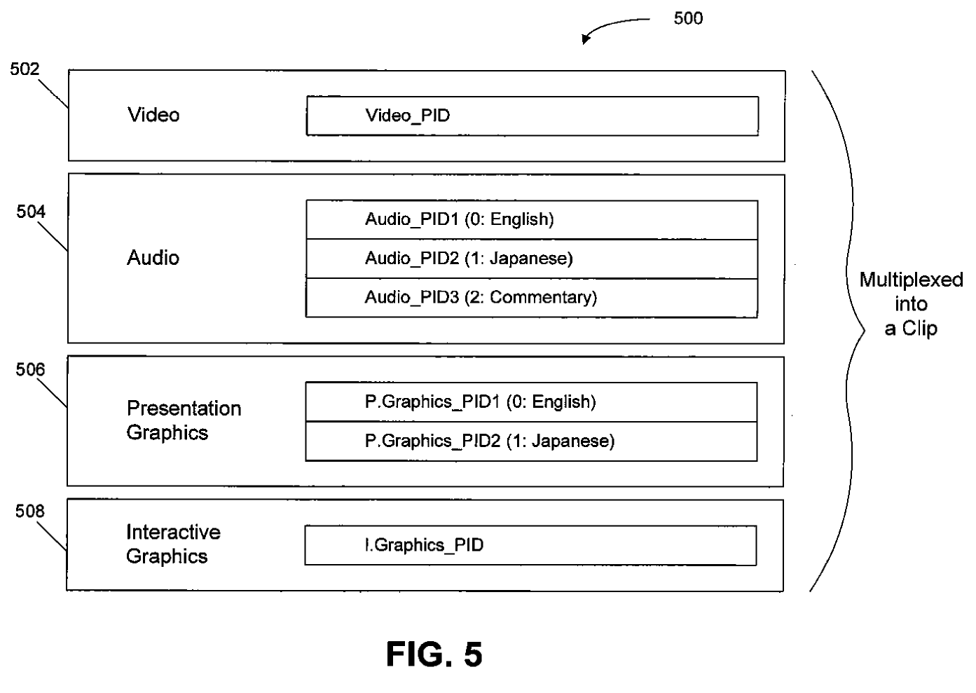

FIG. 5 is a block diagram of an example Clip 500 including Clip AV stream. In the example of FIG. 5, the Clip 500 includes four types of streams, video streams 502, audio streams 504, presentation graphics streams 506, and an interactive graphics stream 508. In other implementations, the Clip 500 can include different numbers of streams as well as different types of streams. For example, the Clip 500 can include a primary video stream, a secondary video stream, and additional graphics streams. The clip can also have fewer streams, for example, the Clip 500 may not include an audio stream, or a video stream, or graphic streams.

In one implementation, a BD authoring system provides effects for graphics. The BD-ROM Specification allows for Interactive Graphics data to be defined in order to introduce interactivity on BD-ROM discs. Data and commands associated with interactive Buttons and graphics that are displayed, such as on menus, are created using Interactive Graphics. In the BD authoring system, the final display is produced by combining video, graphics, and other media that are included in “planes” into a composite output.

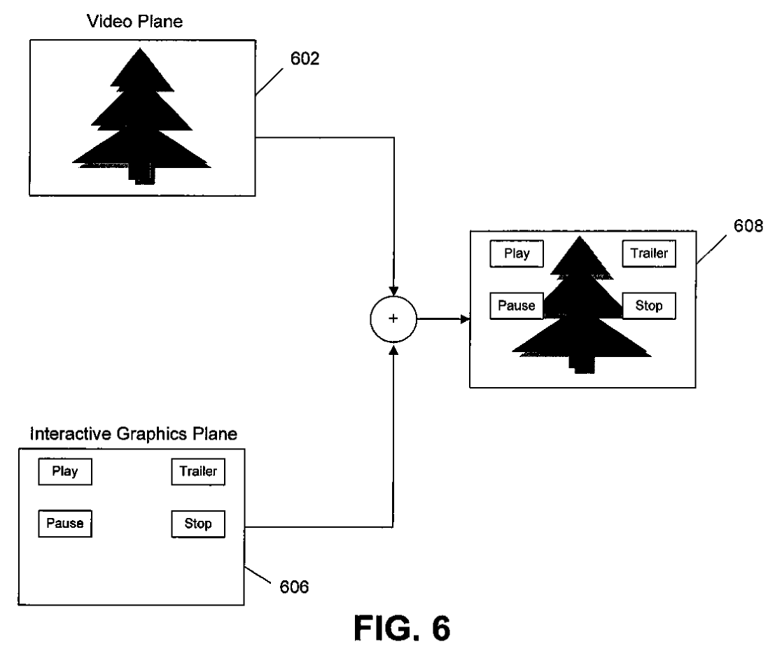

FIG. 6 is a diagram illustrating a combination of planes into a composite output. In the example of FIG. 6 there are two planes, a video plane 602 and an interactive graphics plane 606. The two planes are combined into a composite output 608. In this example, the video plane 602 is running in the background, and the interactive graphics plane 606 is superimposed, or overlayed, onto the video plane 602.

Other planes can also be included in the display. For example, a presentation graphics plane, and text subtitles can also be superimposed onto the final display. The presentation graphics plane, text subtitles, and interactive graphics plane 606 can be composed of multiple layers. The layers can be combined to thereby produce the plane.

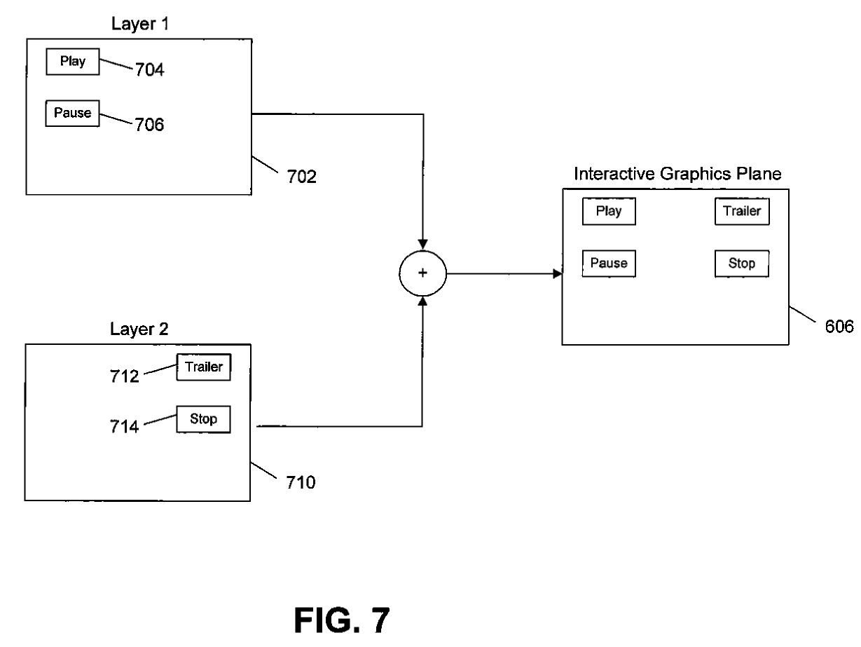

FIG. 7 is a diagram illustrating two layers that make up the example interactive graphics plane 606 illustrated in FIG. 6. As shown in FIG. 7, there is a first layer 702 that includes two buttons, a “Play” button 704 and a “Pause” button 706. There is a second layer 710 that includes two buttons, a “Trailer” button 712 and a “Stop” button 714. The two layers 702 and 710 are combined into the interactive graphics plane 606. In a similar manner, presentation graphics planes and text subtitle planes can also be composed of multiple layers.

In one implementation, a UDA system provides effects for displaying graphics and text in presentation graphics and interactive graphics planes. Blu-Ray Disc (BD-ROM) provides a facility for displaying graphics (Presentation Graphics and Interactive Graphics) and text subtitles. To display graphics and text subtitles, compositions are described that lay out the graphics and text to be displayed on the screen. In many cases, it is desirable to display the graphics and text subtitles with a type of effect. Examples of effects include fade in, fade out, scroll, wipe, color, crop, rotation, scaling, flipping, and cell animations. These effects can be enabled using a series of compositions. For example, the series of compositions can display a graphic in various positions, colors, or transparencies, as the graphic changes from an initial display to a final display. The Blu-Ray Disc Authoring system (BDAS) provides techniques for creating such effects on an efficient manner. Table 1 below lists examples of different types of Effects that can be applied:

TABLE 1
Example Effects

| Effect Type | Action |
|---|---|
| Position Effects | Animate X and Y position. A variation can |
| | be extended to animate the Z position also. |
| Crop Effects | Animate the visible area of one or more |
| | Graphics or Text Subtitle objects. |
| Color Effects | Animate the change of color and |
| | Transparency. |
| Fade Effects | This is a special case of Color Effects |
| | that animates transparency “up”, for |
| | example to 100% (Fade Up), or “down”, for |
| | example to 0% (Fade Down). |
| Wipe Effects | This is a special case of Crop Effect that |
| | animates a crop so that a target object can |
| | be wiped “on” or “off” the screen in a |
| | desired direction (up, down, left or |
| | right). |
| Cell Animations | In some cases, the only way to do a certain |
| | effect is to create a sequence of images |
| | that will be played at a desired rate in |
| | order to achieve the desired function. For |
| | example, in Blu-Ray Disc Movie Mode, Cell |
| | Animation is the only way to achieve a |
| | rotation effect |

The BDAS can convert the effects specified for graphics and text Subtitle events into a series of compositions so that a final graphics or subtitle output can be produced conforming to a required specification. This form of effects definition can be applied to graphics data (Presentation Graphics and Interactive Graphics), text subtitle data and to “In” and “Out” effects.

In another implementation, the BDAS will expose the effects functionality so that the scenarios authored can be output either in HDMV format, or in Enhanced (Java) mode format, or both for a BD-ROM disc. This gives the user a single point of data definition for multiple output forms.

In still another implementation, the BDAS provides “Middle” effects for displaying graphics and text. Middle effects are similar to providing In and Out effects, as described above, but Middle effects pertain to Buttons in an interactive graphics stream. Using Middle effects, the Buttons go through effects while they stay in an Interactive state. Middle effects can be of the same types as specified above. To implement Middle effects, the defined effects can be enabled using a number of Interactive Composition Structures.

In another implementation, the BDAS provides “Transition” effects for displaying graphics and text. Transition effects abstract the concept of In effects so that one or more extra page structures are defined in one or more interactive composition segments so that Buttons on other pages or other objects defined in the BD-ROM specification can start or end with the transition effect. Multiple paths can be built through one Transition effect so that the same series of In effects can be used multiple times. A Transition effect can be entered as an In effects in a page structure. At the end of the In effects (a series of effects) a Button can auto activate to take the control to the desired position. The creation of underlying structures and the setting of the required data can be done automatically by the system and the existence of these structures may, or may not, be hidden from the user. The effects that make up the Transition can be defined using the high level effects described earlier. The Transition effects can be done using In effects, or Out effects, or a is combination of In and Out effects.

In still another implementation, the BDAS can expose the Transition effects functionality so that the scenarios authored can be output either to the HDMV format, or the Enhanced (Java) mode format, or both for a BD-ROM disc. This gives the user a single point of data definition for multiple output forms.

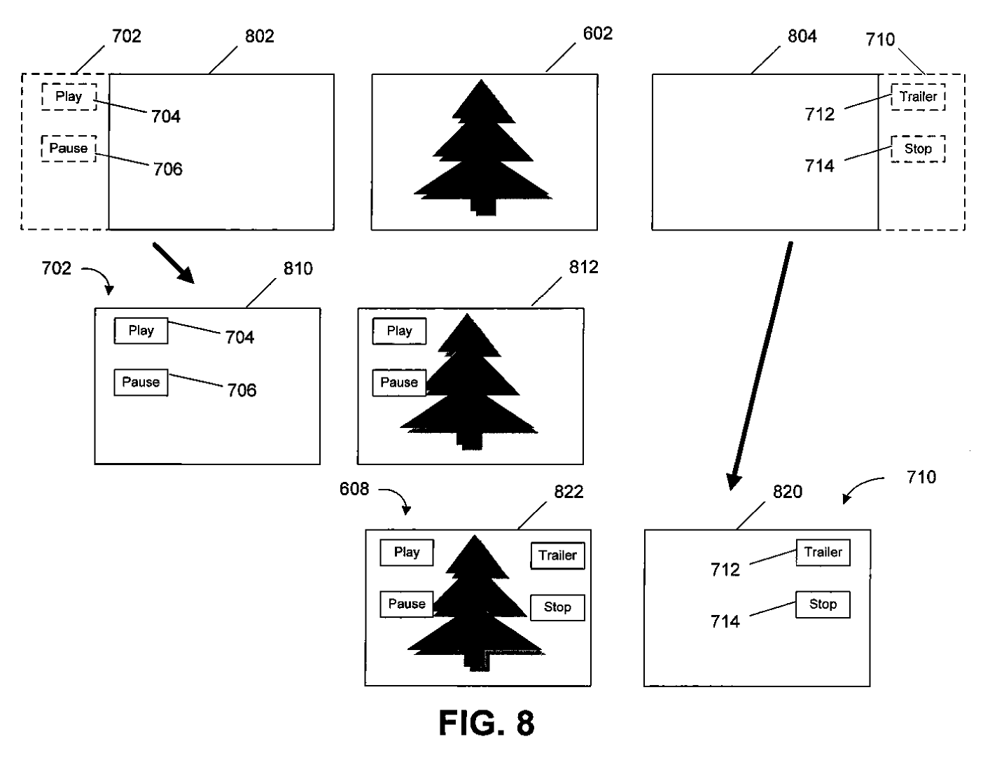

FIG. 8 is a diagram illustrating aspects of an In effect. Shown in FIG. 8 are the two interactive graphics layers 702 and 710 that make up the interactive graphics plane 606 (shown in FIG. 6), and the video plane 602. In this example, before the start of the In effect, the two interactive graphics layers 702 and 710 are positioned so that the buttons are not displayed. For example, display 802 shows the first interactive graphics layer 702 positioned such that the “Play” and “Pause” buttons 704 and 706 are not displayed. Likewise, display 804 shows the second interactive graphics layer 710 positioned such that the “Trailer” and “Stop” buttons 712 and 714 are not displayed. The display presented includes only the video plane 602 with no interactive graphics displayed.

In the example of FIG. 8, the first part of the In effect is to display the “Play” and “Pause” buttons 702 and 704 superimposed onto the video plane 602. Display 810 shows the first interactive graphics layer 702 positioned such that the “Play” and “Pause” buttons 704 and 706 are in a position to be displayed. In this example, the “Trailer” and “Stop” buttons 712 and 714 are not displayed until later, and remain in the position shown for the interactive graphics display 804. The resulting display 812 includes the video display 602 and the first layer of the interactive graphic display 702.

Continuing the example of FIG. 8, the second part of the In effect is to display the “Trailer” and “Stop” buttons 712 and 714 superimposed onto the display 812 resulting from the first part of the In effect. Display 820 shows the second interactive graphics layer 710 positioned such that the “Trailer” and “Stop” buttons 712 and 714 are in a position to be displayed. The resulting display 822 includes the video display with the interactive graphics display 606 superimposed to form the composite 608.

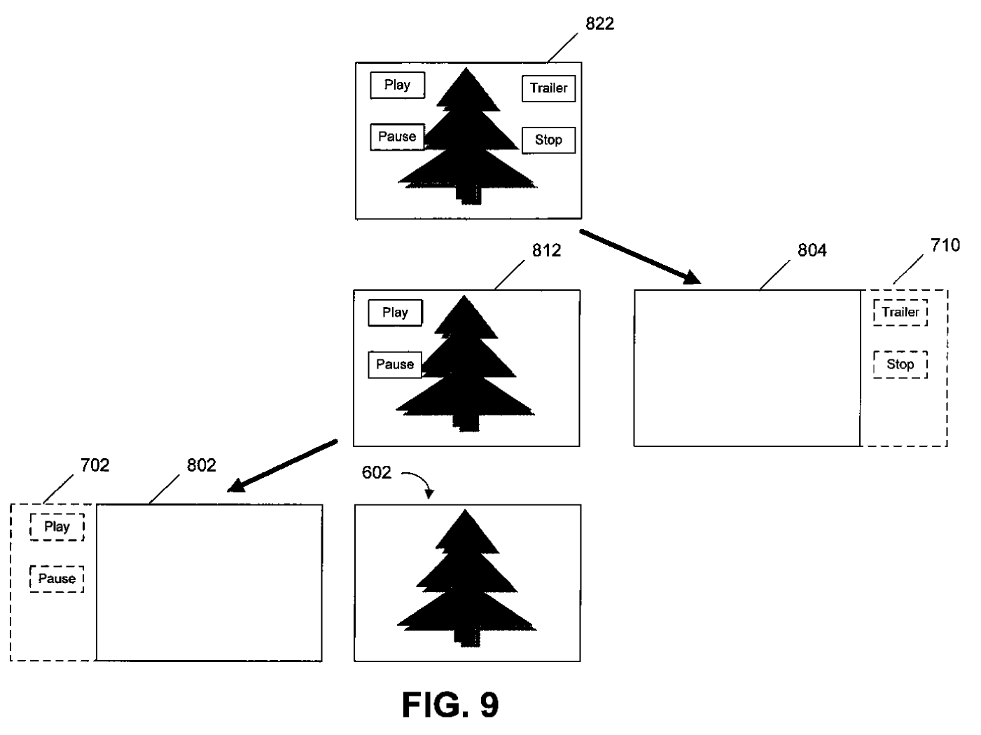

FIG. 9 is a diagram illustrating aspects of an Out effect. The example Out effect illustrated in FIG. 9, begins with the display 822 that includes the video display 602 with the interactive graphics display 606 superimposed. In the beginning of this example Out effect, the second layer of the interactive graphics plane 710 is positioned at display 804 so that the “Trailer” and “Stop” buttons are not displayed resulting in a video display 812.

Continuing the example of FIG. 9, the second part of the Out effect is to position the first layer of the interactive graphics plane 702 such that the “Play” and “Pause” buttons 704, 706 are not displayed as shown in display 802. The video display 602 is shown with no interactive graphics superimposed.

The examples illustrated in FIGS. 8 and 9 are shown as the interactive graphics appearing in the final display in a single step. The interactive graphics can be displayed using other effects as described above. For example the interactive graphics can “Wipe” In or Out of the final display, or fade up or down into the final display, change position on the display, or other effect.

For example, using the BDAS, if a button is to be displayed using a position effect, the user can identify the starting position of the button, the ending position of the button, and the number of steps, or the duration in time, for the button to move from the starting to the ending position. The BDAS can then generate a series of compositions where the button is incrementally repositioned through a desired number of positions or steps on the display so as to move the button from the starting to ending position. It is noted, that the starting and ending positions of the button may, or may not, be on the display.

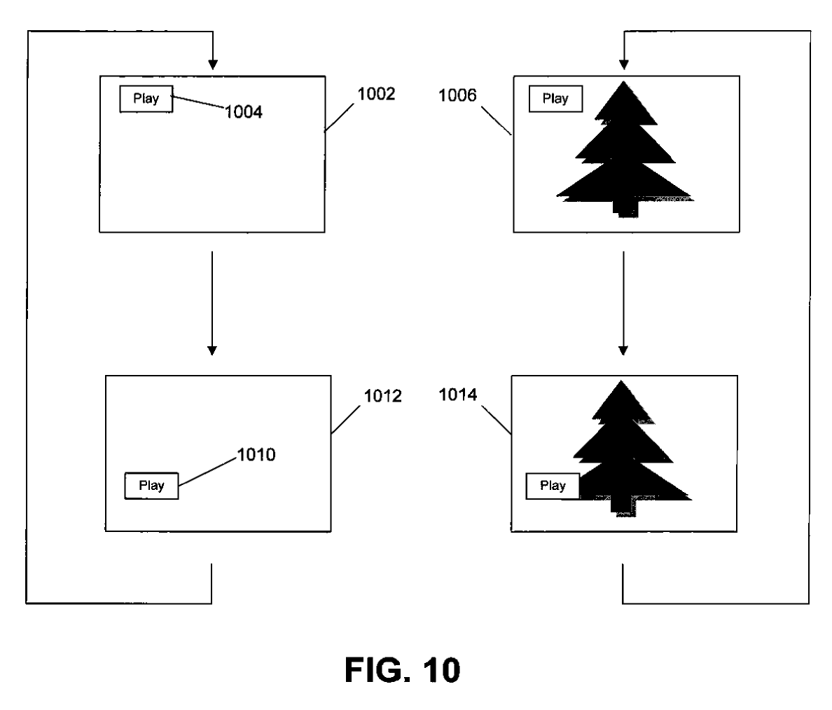

FIG. 10 is a block diagram illustrating aspects of a Middle effect. In the example of FIG. 10, the Middle effect is for a “Play” button to alternate between two different positions on the display. As shown in FIG. 10, a first interactive graphics plane 1002 includes a play button in a first position 1004 in the upper left portion of the first plane 1002. The first interactive graphics plane 1002 is superimposed over a video plane to form a resultant display 1006. Then, the button 1004 moves to a second position 1010 in the lower left portion of a second interactive graphics plane 1012. The second interactive graphics plane 1012 is superimposed over the video plane to form a resultant display 1014. In this example, the first and second interactive graphics planes 1002 and 1012 are alternately superimposed onto the video display to produce resulting alternate displays 1006 and 1014. The duration between alternate displays 1006 and 1014 can be set by a user.

The Middle effect illustrated in FIG. 10 can also use the effects described above. For example, using the BDAS, a user can specify that the button at the starting position 1004 is to Fade out, and then the button at the ending position 1010 is to Fade in. Then the button at the ending position 1010 is to Fade out and then the button in the starting position 1004 is to Fade in. The sequence can be repeated for a desired number of times, or duration, or until a specific action is taken, or a specified event occurs.

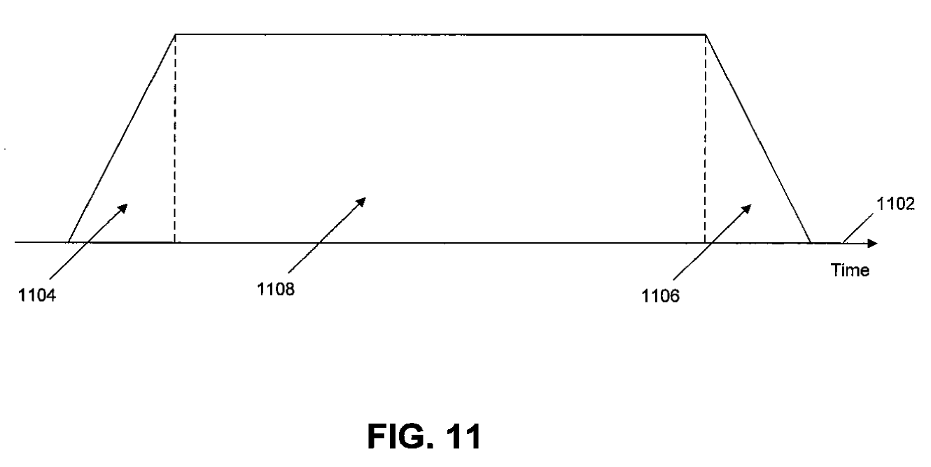

FIG. 11 is a diagram illustrating temporal relationships between In effects, Middle effects, and Out effects. FIG. 11 includes a horizontal line 1102 representing time as increasing to the right. As noted above, an effects plane can be made up of one or more layers. During a period of time 1104 prior to displaying, or presenting, the layer, any In effects associated with the layer are executed. During a period of time 1106 following the removal of the layer from the display, or presentation, any Out effects associated with the layer are executed. During the period of time 1108 that the layer is being displayed, or presented, any Middle effects associated with the layer are executed.

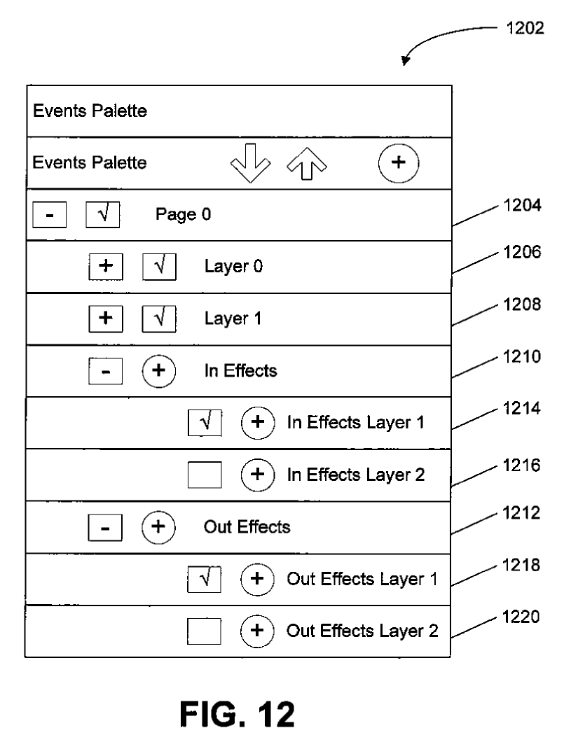

FIG. 12 is an example dialog box that allows a user to control In and Out effects. As noted above, an In effect is executed when a layer is made active and an Out effect is executed when the layer is made inactive. As shown in FIG. 12 a dialog box 1202 for a plane or page 1204 may include multiple layers 1206 and 1208. The dialog box 1202 may also include controls for In effects 1210 and Out effects 1212. In the example of FIG. 12, the page includes two layers, layer 0 and layer 1 (1206 and 1208 respectively). A user may select, or enable, In and Out effects for the individual layers. For example, in FIG. 12, the In effects 1214 for layer 1 have been enabled (indicated by the check mark in the box), and the In effects 121G for layer 2 have not been enabled. Likewise, the Out effects 1218 for layer 1 have been enabled and the Out effects 1220 for layer 2 have not been enabled.

Aspects of different effects can also be controlled by the user of the BDAS in a manner similar to the control of the In and Out effects. For example, a Color effect is used to change an object's color over the duration of the effect.

The object's alpha-channel, or transparency, can also be animated. In using a Color effect, a user can define, or set, start and end colors. The color effect can also be defined as a multiplier on top of an existing color values in the image. Color multipliers can be defined in two color spaces: RGBA and YCbCrT. Each channel multiplier in RGBA may be listed as a percentage, or a value ranging from 0 to 255. If the channel multiplier in RGBA is listed as a percentage, then a multiplier value of {0, 0, 0} would represent converting the image colors to Black (x*0=0), while {100, 100, 100} would keep the image colors unchanged. It is noted that these values act as multipliers on the original image's colors.

In another example, an image can start with its original colors and transparency. The ending image can be the same image with 50 percent intensity and transparency. In addition, the number of steps to be taken from the beginning to the end can be set. The BDAS can determine an optimal value for the number of steps if the user desires. In this case, the maximum value possible within BD-ROM format constraints can be calculated automatically and used for the number of steps.

A Crop effect can be used to trim an object in its current location in an Effect layer. Crop parameters are specified with reference to the full screen rather than the object itself. In a Crop effect, a user first defines a starting location which is the upper left corner on a rectangular region, and a height and width of the region to be cropped. The user can also defined the number of steps for the cropping, or let the BDAS automatically calculate the number of steps.

A Fade effect allows an object to either fade into or out of view. Using the BDAS, a user can specify the type of fade, such as Fade In or Fade Out, a duration and a number of animated steps. For example, a user can specify that a fade duration be a desired period of time, such as 5 seconds, or a desired number of frames. The user can also specify the number of steps to use in completing the fade or the number of steps can be calculated by the BDAS.

A Position effect can be used to make an object move from one position to another on the display. It is noted that the start or end position may or may not be on the screen. The Position effect coordinates can be considered to be referenced to the upper left corner of the screen (absolute to the screen) or the upper left corner of the image (relative to the image). For example, consider an object with the following coordinates that is desired to be scrolled In horizontally from off-screen on the left. In this example, defining a start X position as −618 may put the complete object immediately off-screen to the left. An End position can be specified as the original location of the image which is 0,0 with respect to the upper left corner of the screen. The user can then specify the desired number of steps for the object to move from the start position to the end position, or the number of steps can be calculated.

A Wipe effect is a combination of Position and Crop effects. Similarly to the Fade effect, the type, duration, and number of steps need to be specified. For example, a user may desire to implement a Wipe from the bottom of the image. The user can specify a Wipe type as “Wipe from bottom”, a desired duration, such as 5 seconds, and a desired number of steps to complete the Wipe, such as 120 steps. Also, the BDAS can automatically calculate a number of steps for the Wipe effect.

A Cell Animation Effect is an effect that is presented using a sequence of images. In cell animation, a number of images may be specified that determine a number of steps in that the animation effect (typically the actual number of steps will dependent on interactions with other effects that are taking place at the same time). Each image may be presented as one composition. Effects such as “rotates” may be done using cell animations. A user may also specify a certain area of the supplied images to be used for the cell animation effect.

Other examples of effects include: Slide-In Main Menu Bar; Drop-Down Sub-Menu; Open up Sub-Menu from Bottom; and Fade In/Out Main Menu.

Options can also be presented to adjust the type of motion for the different types of effects given above. These types of motion include linear, speed-up, and slow-down. For non-linear motion, the user can also define an acceleration or deceleration rate to control the non-linear function. Additionally, predefined motion curves can also be presented by the application so that the effect can be easily defined to follow the required curve. For example, a user may be given an option of enabling such a non-linear effect in one of two ways: (a) the time between each step remains the same but the amount of change between each step is controlled by the non-linear function; (b the amount of change between each step is the same but the time for each step is controlled by the non-linear function. A user can also define an effect in terms of the velocity (e.g., in pixels/frame). The usage of the velocity is a technique to define effects for differently-sized objects such that the object's motion to the final viewer seems similar for the differently-sized objects.

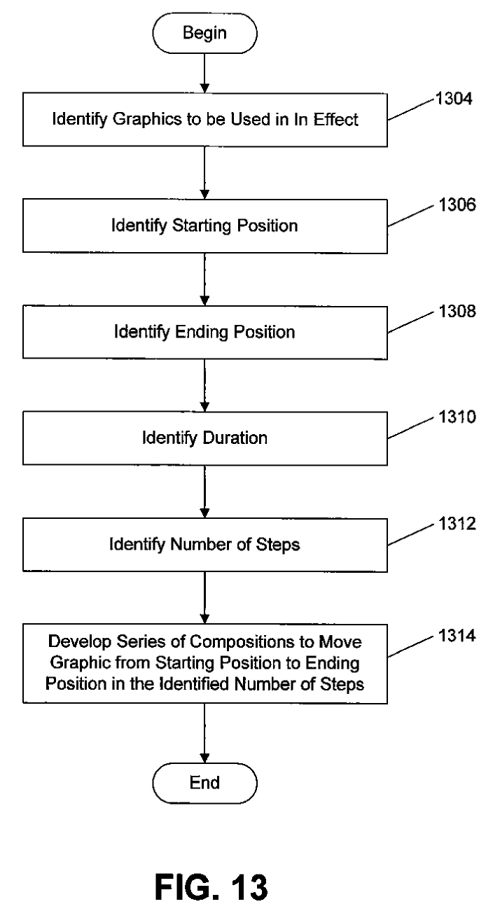

FIG. 13 is a flow diagram of a method of implementing In effects. A user initially identifies, at block 1304, graphics that are to be displayed using an In effect. A starting position for the graphics is identified by the user at block 1306 and an ending position for the graphics is identified at block 1308. Then the user identifies the duration for the In effect at block 1310. In this example, the duration of the In effect describes how long it will take the graphic to move from its starting position to its ending position. Then the user identifies the number of steps for the In effect at block 1312. In this example, the number of steps identifies the incremental change in the position of the graphic in each of the series of compositions used to produce the In effect. In block 1314 a series of compositions to move the graphic from its starting position to its ending position, in the identified number of steps, is developed. For example, if a transition is to move a graphic in a straight line from a starting position to an ending position in 10 steps, then a series of compositions could be developed with the graphic repositioned one-tenth further along the line in each subsequent composition in the series. Implementing an Out effect would be similar to the above description.

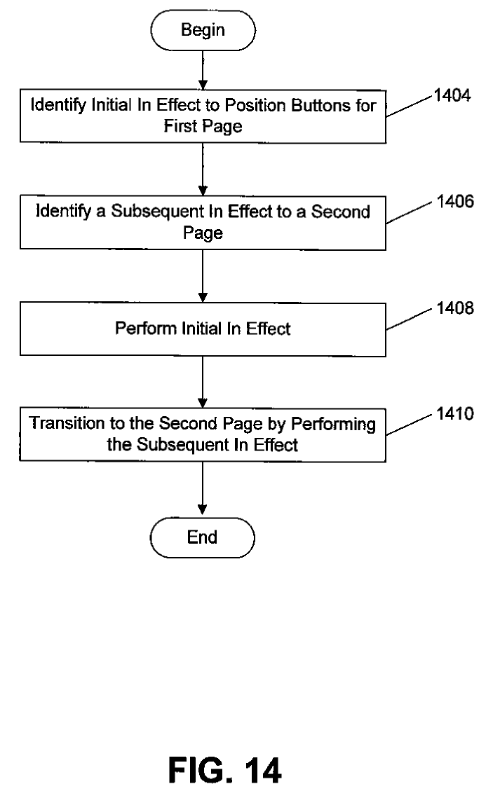

FIG. 14 is a flow diagram of a method of implementing a Transition effect. A user identifies an initial In effect to position Buttons at desired locations in a first page, at block 1404. The user defines a subsequent In effect to position Buttons at desired locations in a second page, at block 1406. Then, the In effect for the first page is performed at block 1408. Then after a desired period of time, there is a transition to the In effect for the second page at block 1410. The Buttons on the first and second pages can include some, or all, of the same Buttons. Also, effects, such as fade, wipe, or position, or any other effect, can be used during the transition. For example, if there is a Button defined in the first page, but that same button is not in the second page, that button could “Fade Out” during the transition. Likewise, if there is a Button that is in the second page that was not in the first page, that Button could “Fade In” during the transition. The Fade in and Fade out of the buttons can be performed with a series of compositions. For example, for the button fading out, the series of compositions is such that in each subsequent composition of the series, the transparency of the button is increased until the button is no longer visible. Likewise, for the button fading in, the series of compositions is such that in each subsequent composition of the series, the button fading in has decreased transparency until the button is visible.

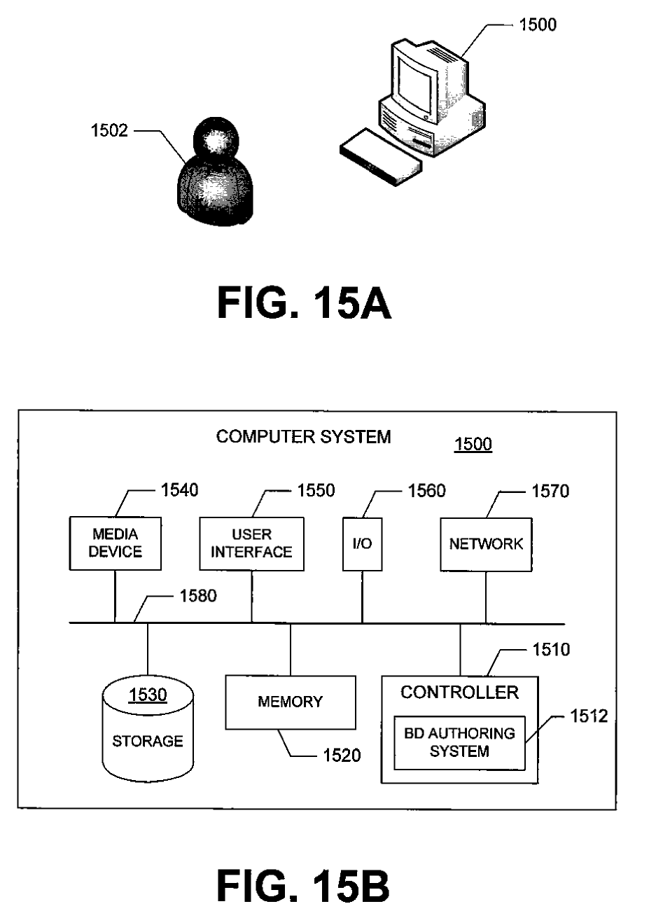

FIG. 15A shows a representation of a computer system 1500 and a user 1502. The user 1502 can use the computer system 1500 to author a Blu-ray disc. The computer system 1500 stores and executes a BD authoring system 1512 (shown in FIG. 15B), which receives BD-ROM data as an input and outputs an abstraction of the BD-ROM data. In one example, the BD authoring system 1512 provides effects in interactive graphics.

FIG. 15B shows a block diagram of one implementation of the computer system 1500 in FIG. 15A, including the BD authoring system 1512. The computer system 1500 includes a controller 1510, a memory 1520, storage 1530, a media device 1540, a participant interface 1550, an input/output (I/O) interface 1560, and a network interface 1570. These components are interconnected by a common bus 1580. Alternatively, different connection configurations can be used, such as a star pattern with the controller at the center.

The controller 1510 is a programmable processor and controls the operation of the computer system 1500 and its components. The controller 1510 loads instructions from the memory 1520 or an embedded controller memory (not shown) and executes these instructions to control the system. In its execution, the controller 1510 provides the BD authoring system 1512 as a software system. Alternatively, this service can be implemented as separate components in the controller 1510 or the computer system 1500.

Memory 1520 stores data temporarily for use by the other components of the computer system 1500. In one implementation, memory 1520 is implemented as RAM. In one implementation, memory 1520 also includes long-term or permanent memory, such as flash memory and/or ROM.

Storage 1530 stores data temporarily or long term for use by other components of the computer system 1500, such as for storing BD data used by the BD authoring system 1512. In one implementation, storage 1530 is a hard disk drive.

The media device 1540 receives removable media and reads and/or writes data to the inserted media. In one implementation, the media device 1540 is an optical disc drive.

The user interface 1550 includes components for accepting user input from the user of the computer system 1500 and presenting information to the user. In one implementation, the user interface 1550 includes a keyboard, a mouse, audio speakers, and a display. The controller 1510 uses input from the user to adjust the operation of the computer system 1500.

The I/O interface 1560 includes one or more I/O ports to connect to corresponding I/O devices, such as external storage or supplemental devices (e.g., a printer or a PDA). In one implementation, the ports of the I/O interface 1560 include ports such as: USB ports, PCMCIA ports, serial ports, and/or parallel ports. In another implementation, the I/o interface 1560 includes a wireless interface for communication with external devices wirelessly.

The network interface 1570 includes a wired and/or wireless network connection, such as an RJ-45 or “Wi-Fi” interface (802.11) supporting an Ethernet connection.

The computer system 1500 includes additional hardware and software typical of computer systems (e.g., power, cooling, operating system), though these components are not specifically shown in FIG. 15B for simplicity. In other implementations, different configurations of the computer system can be used (e.g., different bus or storage configurations or a multi-processor configuration).

Various illustrative implementations of the present invention have been described. However, one of ordinary skill in the art will recognize that additional implementations are also possible and within the scope of the present invention. For example, although the disc authoring system has been described exclusively in terms of the BD format, the system can be used to author discs in formats other than the BD format (e.g., the HD-DVD format). In addition, while the techniques have been described for use with interactive graphics and presentation graphics they can be used with other graphics as well as with Java composition.

Accordingly, the present invention is not limited to only those implementations described above.

What is claimed is:

1. A method for authoring a Blu-ray Disc, the method comprising:
defining layers of graphics to be used in a display;
overlaying the layer on to video display thereby providing a composite display,
wherein overlay includes using an effect.

2. The method of claim 1, wherein the effect comprises a fade.

3. The method of claim 1, wherein the effect comprises a wipe.

4. The method of claim 1, wherein the effect comprises a position effect.

5. The method of claim 1, wherein the effect comprises a color effect.

6. The method of claim 1, wherein the effect comprises a crop effect.

7. The method of claim 1, wherein the effect comprises a cell animation effect.

8. The method of claim 1, wherein the effect comprises a rotation effect.

9. The method of claim 1, wherein the effect comprises a scaling effect.

10. The method of claim 1, wherein the effect comprises a flipping effect.

11. The method of claim 1, wherein the graphics comprises an interactive graphic.

12. The method of claim 1, wherein the graphics comprises a Java composition.

13. The method of claim 1, wherein the graphics comprises a presentation graphic.

14. The method of claim 1, wherein the graphics comprises a subtitle.

15. A Blu-ray Disc authoring system, comprising:
a graphics stream; and
an effect comprising a series of compositions,
wherein the compositions operate to display the graphics stream in a composite output.

16. The system of claim 15, wherein the graphics stream comprises an interactive graphics stream.

17. The system of claim 15, wherein the graphics stream comprises a Java composition.

18. The system of claim 15, wherein the graphics stream comprises a presentation graphics stream.

19. The system of claim 15, wherein the graphics stream comprises a subtitle graphics stream.

20. The system of claim 15, wherein the effect is executed before the graphics plane is active.

21. The system of claim 15, wherein the effect is executed after the graphics plane is inactive.

22. The system of claim 15 wherein the effect is exposed functionally in HDMV format.

23. The system of claim 15, wherein the effect is exposed functionally in enhanced JAVA mode format.

24. An apparatus for authoring a Blu-ray Disc, the apparatus comprising:
means for defining layers of graphics to be used in a display; and
means for overlaying the layer on to video display thereby providing a composite display,
wherein overlaying includes using an effect.

25. An apparatus for authoring a Blu-ray Disc, comprising:
means for identifying a graphics stream; and
means for generating a series of compositions, wherein the compositions operate to display the graphics plane in a composite output.

26. A computer program, stored in a computer-readable storage medium, for authoring a Blu-ray Disc, the program comprising executable instructions that cause a computer to:
define layers of graphics to be used in a display; and
overlay the layers of graphics onto a display thereby providing a composite display,
wherein overlaying includes using an effect.

27. A computer program, stored in a computer-readable storage medium, for authoring a Blu-ray Disc, the program comprising executable instructions that cause a computer to:
identify a graphics plane; and
generate a series of compositions, wherein the compositions operate to display the graphics plane in a composite output.
